(19) United States
(12) Patent Application Publication
(10) Pub. No.: US 2019/0175454 A1
(43) Pub. Date: Jun. 13, 2019

(54) STUFFED TOY WITH AN ENCLOSED PACIFIER FOR WEANING AN INFANT OFF OF THE PACIFIER

(71) Applicant: BinkaBear, LLC, Pittsfield, MA (US)

(72) Inventor: Kaitlyn Pierce, Pittsfield, MA (US)

(73) Assignee: BinkaBear, LLC, Pittsfield, MA (US)

(21) Appl. No.: 16/210,319

(22) Filed: Dec. 5, 2018

Related U.S. Application Data
(60) Provisional application No. 62/596,465, filed on Dec. 8, 2017.

(51) Int. Cl. A61J 17/00; A63H 3/02; A63H 3/00

(52) U.S. Cl. CPC A61J 17/007; A63H 3/003; A63H 3/02

(57) ABSTRACT

A stuffed toy for weaning an infant off of use of an infant-use product, the stuffed toy comprising a pliable exterior cover defining an interior void; a soft stuffing material secured within the void; and, an infant-use product secured within the soft stuffing material.

### CROSS REFERENCE TO RELATED APPLICATION

This application claims the benefit of provisional application Serial No. 62/596,465, filed Dec. 8, 2017.

### TECHNICAL FIELD

This disclosure relates to use of pacifiers to comfort infant children and in particular relates to a stuffed toy with at least one enclosed pacifier for weaning an infant off of use of the pacifier, and a method of using the stuffed toy therefor.

### BACKGROUND ART

It is well known that new-born infants need frequent feeding for healthy growth and development. This is generally accomplished by a period of breast-feeding by the mother of the infant, which is followed up by bottle feeding of a liquid infant formula. Bottles for such feeding utilize a soft nipple-shaped outlet that permits the infant to continue a sucking action to withdraw the formula. Infants become so comfortable with this sucking action that they are frequently uncomfortable when they cannot continue the sucking action. This discomfort typically leads to crying and disruption of the environment near the infant, as well as genuine aggravation and sleep disruption of the infant.

To comfort the non-feeding infant, infant pacifiers have been developed and used to permit the infant to continue the sucking action. Such pacifier are well known and are available in many forms, but the majority take a somewhat standard form and shape, as shown in FIG. 2. Pacifiers work very well and generally lead to healthier, happier infants. Unfortunately, however, some infants become so dependent upon their pacifiers that it becomes very difficult to wean the infant off of her or his pacifier. For proper development of the teeth of the infant and transitioning to eating solid food, it is generally recommended that children be weaned from their pacifiers well before they reach their first birthday.

What develops within a busy household however, is that removing a pacifier from an infant results in the infant crying tirelessly which gives rise to both irritation amongst the infant's care-giver(s), and lack of sleep and nervous irritation of the infant; all unhealthy conditions. Frequently, the care-giver simply allows the infant to use a pacifier for many months and often years after an optimal time to wean the child from the pacifier. This gives rise to a possibility of developmental difficulties of such a child who may be exposed to children of the same age that do not use pacifiers, as well as many other common problems.

Consequently there is a need for a way to more effectively wean an infant from use of a pacifier.

### SUMMARY

In accordance with the present disclosure, there is provided a stuffed toy for weaning an infant off of use of a pacifier, the stuffed toy comprising: a. a pliable exterior cover defining an interior void; b. a soft stuffing material secured within the void; and, c. a pacifier secured within the soft stuffing material.

In another and alternative embodiment, the exterior cover of the stuffed toy defines a protrusion extending away from a main body of the stuffed toy, and wherein the pacifier is secured within the protrusion.

In another and alternative embodiment, the exterior cover of the stuffed toy defines a plurality of protrusions extending away from a main body of the stuffed toy, and wherein at least two pacifiers are secured within the plurality of protrusions.

In another and alternative embodiment, the exterior cover includes a child-proof entry slit between the protrusion and the main body of the stuffed toy, the child-proof entry slit being for insertion and removal of the pacifier into and out of the protrusion of the stuffed toy.

In another and alternative embodiment, the stuffed toy further comprises a. the protrusion defining a longest cross-length of the protrusion that is defined by a straight axis of the protrusion extending from a first side of the protrusion, through the protrusion, and to a second side of the protrusion opposed to the first side of the protrusion; b. the pacifier defining a longest cross-length of the pacifier that is defined by a straight axis passing between opposed points of the pacifier that are farther from each other than any other opposed points of the pacifier; and, c. wherein the longest cross-length of the protrusion is no greater than about twenty-five percent greater than the longest cross-length of the pacifier.

In accordance with the present disclosure, there is provided a stuffed toy for weaning an infant off of use of an infant-use product such as a pacifier or bottle, the stuffed toy comprising an exterior cover defining an interior void; a stuffing material secured within the void; and at least one slit configured to receive the infant use product within the interior void.

In another and alternative embodiment, the at least one slit is configured to prevent an infant or child from opening the at least one slit.

In another and alternative embodiment, the at least one slit comprises opposed sides.

In another and alternative embodiment, the stuffed toy further comprises a lacing passed through the opposed sides of the slit the lacing configured to knot or bond to prevent a child from unlacing the secure slit.

In another and alternative embodiment, the stuffed toy further comprises a flap coupled proximate the at least one slit; the flap configured to fold over the slit and hide the slit.

In another and alternative embodiment, the flap includes at least one coupler configured to removably couple with at least one securing patch proximate the slit.

In another and alternative embodiment, the at least one coupler is selected from the group consisting of a hook-and-loop fastener, an adhesive, a snap and a button.

In another and alternative embodiment, the stuffed toy of further comprises at least one protrusion formed in the exterior cover, the at least one protrusion including the at least one slit.

In another and alternative embodiment, the stuffed toy further comprises at least one wall within the interior void coupled to the exterior cover configured as a compartment formed within the interior void proximate the at least one slit, the compartment configured to contain the infant-use product.

In another and alternative embodiment, the at least one wall is selected from the group consisting of a few threads passing from opposed sides of the slit, a net, a webbing, and a fabric barrier.

In accordance with the present disclosure, there is provided a method of using a stuffed toy for weaning an infant off of use of a pacifier, the method comprises familiarizing a child with a stuffed toy comprising an exterior cover defining an interior void; a stuffing material secured within the void; and at least one slit configured to receive the pacifier within the interior void; inserting the pacifier into the at least one slit while the child watching, such that the child understands that the pacifier is within the stuffed toy; and encouraging the child to hold the stuffed toy.

In another and alternative embodiment, the method of further comprises removing the pacifier from the interior void and replacing the pacifier to the interior void for a decreasing time interval; and determining that the child has been weaned from using the pacifier.

In another and alternative embodiment, the method further comprises utilizing a visual image of the stuffed toy in a story book; illustrating with the story book a story of the pacifier being inserted into the interior of the stuffed toy and the pacifier being stored within the interior.

### BRIEF DESCRIPTION OF THE DRAWINGS

FIG. 1 shows a perspective view of a stuffed toy in the form of a common stuffed “teddy bear” having a plurality of protrusions from a main body of the toy; the protrusions being in the form of two arms and two legs of the teddy bear.

FIG. 2 shows a perspective view of a common pacifier.

FIG. 3 shows the stuffed toy of FIG. 1 including in a cut-away view a first pacifier within a first protrusion or first foot of the stuffed toy, and including in a cut-away view a second pacifier within a second protrusion or first arm of the stuffed toy.

### DESCRIPTION THE DISCLOSURE

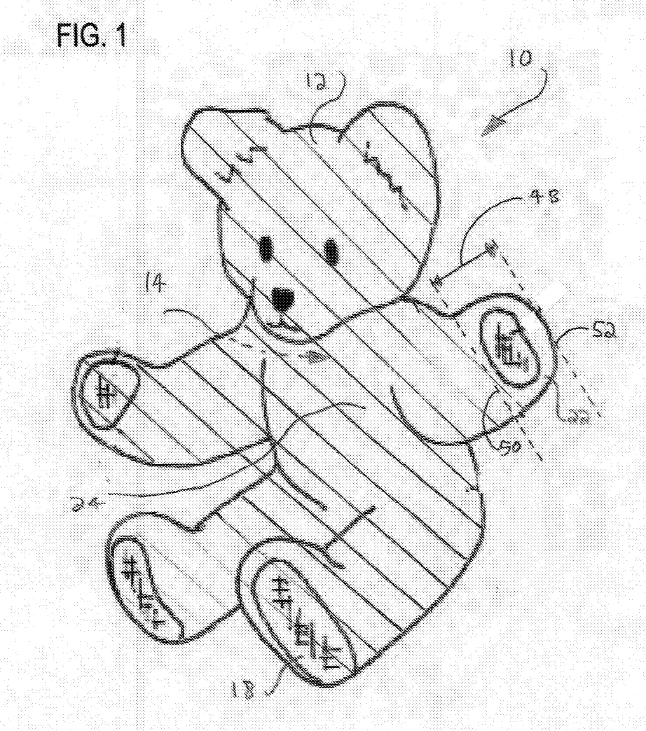

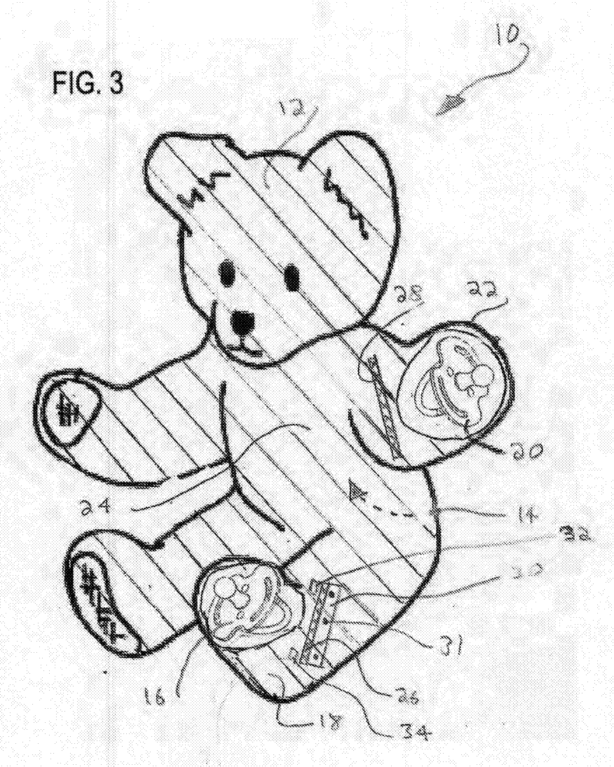

The disclosure includes a stuffed toy that is generally designated by the reference numeral 10 and is show in FIGS. 1 and 3. The stuffed toy 10 includes a pliable, exterior cover 12 that defines an interior void 14 such as are common in stuffed toys known in the art. A soft stuffing material (not shown) is secured within the void 14. While FIGS. 1 and 3 show the stuffed toy 10 as a common teddy bear, it is to be understood that for purposes of this disclosure the “stuffed toy” may take virtually any shape, from a simple rectangular, circular, or irregular shaped change-purse sized soft toy, to a large octopus, giraffe, or cartoon-shaped soft toy with many protrusions, etc.

As shown in FIG. 3, a first pacifier 16 may be secured within a first protrusion 18, or first foot 18, of the stuffed toy 10, while a second pacifier 20 may be secured within a second protrusion 22, or first arm 22, of the stuffed toy 10.

It is to be understood that the stuffed toy may have only one pacifier 16, or two or more (a plurality of) pacifiers. The stuffed toy 10 of FIGS. 1 and 3 may have a pacifier in each of the four protrusions (two arms and two feet) extending from the main body 24, or in only one of the four protrusions. Moreover, the stuffed toy may be formed to have one special protrusion (not shown) for the pacifier 16, 20 that is longer than the other protrusions 18, 22 to facilitate grasping of the pacifier 16, 20 within the stuffed toy 10 by the child (not shown).

The pliable, exterior cover 12 of the stuffed toy 10 may also include a first child-proof entry slit 26 adjacent the first protrusion 18, and a second child-proof entry slit 28 for insertion and removal of the first and second pacifiers 16, 20 from the interior void 14 of the stuffed toy 10. The child-proof entry slits or simply slit 26, 28 may be any secure slits that would prevent an infant or child from opening the slits. The toy 10 may include lacing through opposed sides of the slits 26, 28 and knotting and or bonding of lace ends to prevent a child from unlacing the slits 26, 28. The stuffed toy 10 may also include a slit-hiding flap 30 proximate the slit 26, 28. The flap 30 can fold over to hide a laced slit 28.

In an exemplary embodiment, the flap 30 can include a coupler 31. The coupler 31 is configured to secure the flap 30 closed. The coupler 31 can include hook-and-loop (e.g. “Velcro”), a snap, a button, or adhesive on the flap 30. The coupler 31 is configured to couple to a first securing patch, 32 and/or a second securing patch 34 to secure the folded over flap 30, as shown in FIG. 3.

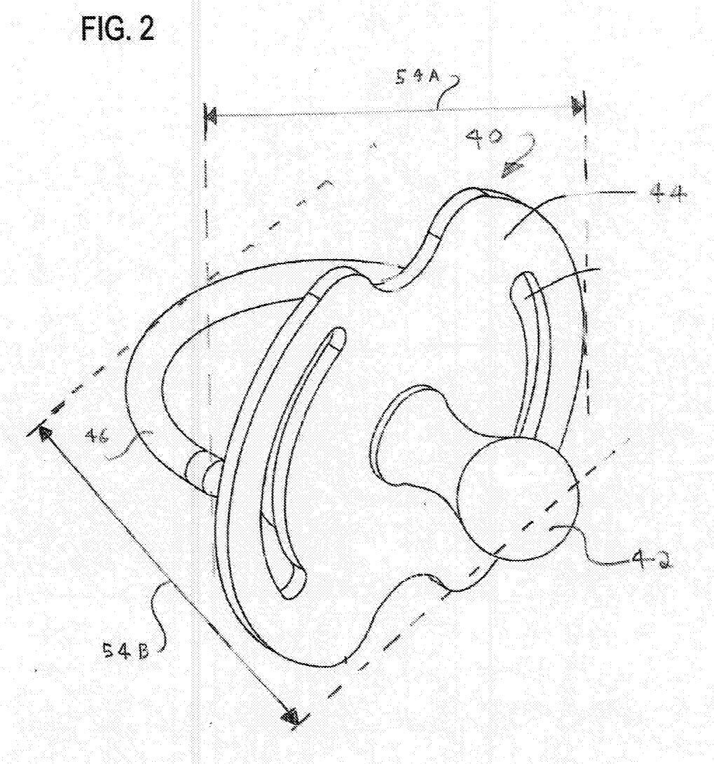

FIG. 2 shows a standard pacifier 40 that includes a pliable suction bulb 42, a pliable lip bumper 44, and a securing loop 46 secured to the bumper 44 to facilitate handling of the pacifier 40.

While the stuffed toy 10 may be any shape that would permit an infant to grasp the pacifiers 16, 20 within the toy, it to be understood that a protrusion housing a pacifier cannot be so large that the infant is unable to grasp a pacifier within the protrusion. Therefore, the stuffed toy 10 may be formed so that one of the protrusions 22 that houses a pacifier 16 defines a longest cross-length 48 of the protrusion 22 defined by a straight axis 48 of the protrusion 22 extending from a first side 50 of the protrusion 22, through the protrusion 22, and to a second side 52 of the protrusion 22 opposed to the first side 50 of the protrusion.

Additionally, and as shown in FIG. 2, the pacifier 40 may be structured to define a longest cross-length 54A, 54B of the pacifier 40 that is defined by a straight axis 54A, 54B passing between opposed points of the pacifier 40 that are farther from each other than any other opposed points of the pacifier 40. To make sure the protrusion 22 is not so large that an infant cannot grasp the pacifier 20 within the protrusion, the longest cross-length 48 of the protrusion 22 is no greater than about twenty-five percent greater than the longest cross-length 54A, 54B of the pacifier.

The disclosure also includes a method of use of the stuffed toy 10 with an enclosed pacifier 16, 20 for weaning an infant off of the pacifier 16, 20. The method includes the steps of familiarizing an infant (not shown) with the stuffed toy 10 prior to inserting one or more of the infant's pacifiers 16, 20 within the toy 10 so that the infant forms a happy, tactile relationship with the stuffed toy 10. Then, placing one or more of the pacifiers 16, 20 within the familiar stuffed toy 10 while the infant is watching and/or helping to insert the pacifiers 16, 20, so that the infant understands the pacifiers 16, 20 are within the stuffed toy 10. And, then encouraging the infant to hold the stuffed toy 10 by the protrusions 18, 22 that hold the pacifiers 16, 20. If necessary, one or more of the pacifiers 16, 20 may be removed and then replaced for constantly decreasing time intervals until the infant is completely weaned from using the pacifiers 16, 20. The infant will refrain from inserting the pliable exterior surface 12 of the stuffed toy 10 into the mouth of the infant because of a non-smooth surface of the toy 10 cover 12. Yet, the infant will be comforted by the feel of the infant's pacifier(s) 16, 20 in the infant's hands and with the infant's favorite stuffed toy 10.

The method may also include an additional step of utilizing visual images in a child's story book that shows a friendly stuffed toy, visually like the stuffed toy 10, wherein the story shows insertion and storage of pacifiers within protrusions of the stuffed toy image. A particular stuffed toy (not shown) under the trademark “BINKA BEAR” may be the subject of the child's story book, and may have a special appearance with a protrusion uniquely structured to facilitate grasping and feeling the pacifier once secured within the stuffed toy.

The stuffed toy 10 may also have walls (not shown) within the protrusions 16, 20 to form compartments that prohibit the pacifier from leaving the protrusion and becoming misplaced within the main body 24 of the stuffed toy 10. The walls (not shown) may simply be a few threads passing from opposed sides of the protrusion, between the entry slits 26, 28 and the main body 24 of the stuffed toy 10 to prevent movement of the pacifier. Or, the walls may be formed by a net, a webbing, or a partial or complete fabric barrier.

For purposes herein, the word “about” is to mean plus or minus twenty percent.

While the present disclosure has been presented above with respect to the described and illustrated embodiments of the stuffed toy 10 with an enclosed pacifier 16, 20 for weaning an infant off of the pacifier 16, 20, it is to be understood that the disclosure is not to be limited to those alternatives and described embodiments. For example, the present disclosure is to be understood to also include infant-use products secured within the soft toy, such as a bottle utilized to feed infants, instead of a pacifier. Frequently, infants become very used to, or dependent upon being put into a calm disposition by use of a soft, nipple-shaped outlet of a feeding bottle. Therefore, this disclosure also includes a stuffed toy for weaning an infant off of use of a feeding bottle, wherein the stuffed toy includes a pliable exterior cover defining an interior void; a soft stuffing material secured within the void; and, a baby feeding bottle secured within the soft stuffing material. Additionally, the soft toy may have at least one protrusion dimensioned to receive and secure within the protrusion the baby feeding bottle.

What is claimed is:

1. A stuffed toy for weaning an infant off of use of a pacifier, the stuffed toy comprising:
a. a pliable exterior cover defining an interior void;
b. a soft stuffing material secured within the void; and,
c. a pacifier secured within the soft stuffing material.

2. The stuffed toy of claim 1, wherein the exterior cover of the stuffed toy defines a protrusion extending away from a main body of the stuffed toy, and wherein the pacifier is secured within the protrusion.

3. The stuffed toy of claim 1, wherein the exterior cover of the stuffed toy defines a plurality of protrusions extending away from a main body of the stuffed toy, and wherein at least two pacifiers are secured within the plurality of protrusions.

4. The stuffed toy of claim 2, wherein the exterior cover includes a child-proof entry slit between the protrusion and the main body of the stuffed toy, the child-proof entry slit being for insertion and removal of the pacifier into and out of the protrusion of the stuffed toy.

5. The stuffed toy of claim 2, further comprising:
a. the protrusion defining a longest cross-length of the protrusion that is defined by a straight axis of the protrusion extending from a first side of the protrusion, through the protrusion, and to a second side of the protrusion opposed to the first side of the protrusion;
b. the pacifier defining a longest cross-length of the pacifier that is defined by a straight axis passing between opposed points of the pacifier that are farther from each other than any other opposed points of the pacifier; and,
c. wherein the longest cross-length of the protrusion is no greater than about twenty-five percent greater than the longest cross-length of the pacifier.

6. A stuffed toy for weaning an infant off of use of an infant-use product such as a pacifier or bottle, the stuffed toy comprising:
an exterior cover defining an interior void;
a stuffing material secured within the void; and
at least one slit configured to receive the infant use product within the interior void.

7. The stuffed toy of claim 6, wherein said at least one slit is configured to prevent an infant or child from opening said at least one slit.

8. The stuffed toy of claim 6, wherein said at least one slit comprises opposed sides.

9. The stuffed toy of claim 8, further comprising:
a lacing passed through the opposed sides of said slit said lacing configured to knot or bond to prevent a child from unlacing said secure slit.

10. The stuffed toy of claim 6, further comprising:
a flap coupled proximate said at least one slit;
said flap configured to fold over said slit and hide said slit.

11. The stuffed toy of claim 10, wherein said flap includes at least one coupler configured to removably couple with at least one securing patch proximate said slit.

12. The stuffed toy of claim 11, wherein said at least one coupler is selected from the group consisting of a hook-and-loop fastener, an adhesive, a snap and a button.

13. The stuffed toy of claim 6, further comprising:
at least one protrusion formed in said exterior cover, said at least one protrusion including said at least one slit.

14. The stuffed toy of claim 6, further comprising:
at least one wall within said interior void coupled to said exterior cover configured as a compartment formed within said interior void proximate said at least one slit, said compartment configured to contain said infant-use product.

15. The stuffed toy of claim 14, wherein said at least one wall is selected from the group consisting of a few threads passing from opposed sides of the slit, a net, a webbing, and a fabric barrier.

16. A method of using a stuffed toy for weaning an infant off of use of a pacifier, the method comprising:
familiarizing a child with a stuffed toy comprising an exterior cover defining an interior void; a stuffing material secured within the void; and at least one slit configured to receive the pacifier within the interior void;
inserting said pacifier into said at least one slit while said child watching, such that said child understands that the pacifier is within said stuffed toy; and
encouraging said child to hold said stuffed toy.

17. The method of claim 16, further comprising:
removing said pacifier from said interior void and replacing said pacifier to said interior void for a decreasing time interval; and
determining that said child has been weaned from using said pacifier.

18. The method of claim 16 further comprising:
utilizing a visual image of said stuffed toy in a story book;
illustrating with said story book a story of said pacifier being inserted into said interior of said stuffed toy and said pacifier being stored within said interior.
